(19) United States
(12) Patent Application Publication
(10) Pub. No.: US 2024/0351843 A1
(43) Pub. Date: Oct. 24, 2024

(54) Treatment System for Treating Kegs

(71) Applicant: KHS GmbH, Dortmund (DE)

(72) Inventors: Volker Damerow, Uelversheim (DE); Sebastian Eckes, Langenlonsheim (DE); Maximilian Weindorf, Münsterappel (DE); Christian Pedersen, Kriftel (DE); Manfred Wahl, Obewiesen (DE); Andreas Weber, Bad Sobernheim (DE); Olaf Muszinski, Bad Soden (DE)

(21) Appl. No.: 18/682,995

(22) PCT Filed: Aug. 30, 2022
(86) PCT No.: PCT/EP2022/074061

§ 371 Date: Feb. 12, 2024

(30) Foreign Application Priority Data
Aug. 31, 2021 (DE) 102021122472.1

(51) Int. Cl. B67C 3/00; B67C 3/30

(52) U.S. Cl. CPC B67C 3/007; B67C 3/001; B67C 3/30

(57) ABSTRACT

The invention relates to a treatment system for treating containers, in particular for treating kegs, each of which is preferably equipped with at least one keg fitting. The treatment system has at least one media supply for a product to be filled and/or for one or more treatment or cleaning media as well as at least one treatment station for receiving a container, in particular keg. The treatment station has at least one treatment head for cleaning the interior of and/or filling the container, in particular keg, and at least one supply interface via which the treatment station is connected to the media supply. According to the invention, at least one closure device for tightly closing the treatment head as well as at least one measuring and checking device for recording and checking process data are further provided in the treatment system for automatically checking installation and/or functioning of the treatment station.

### RELATED APPLICATIONS

This application is the national-stage entry of PCT/EP2022/074061, filed on Aug. 30, 2022, which claims the benefit of the Aug. 31, 2021 priority date of DE 102021122472.1, the contents of which are incorporated herein by reference.

### FIELD OF INVENTION

The present invention relates to a treatment system for treating containers, in particular for treating kegs, each of which is preferably equipped with at least one keg fitting. The invention further relates to a closure device for use during an automatic installation test and/or function test of a treatment station of a treatment system, as well as to a method for the installation testing and/or function testing of a treatment station of a treatment system, and to a software program for a treatment system.

### BACKGROUND

From the sector of the beverage industry, different types of containers are known for the filling of a liquid filling product, in particular for the filling of beverages. Accordingly, in this situation, use is made as a rule of bottles, cans, or barrel-like containers, which are also used, for example, for repeated use in accordance with the reusable principle.

Reusable barrels, also referred to as kegs or keg barrels or keg containers, are well-known in the beverage industry. Such kegs are provided with corresponding connections, by means of which both internal cleaning and filling of the kegs are carried out with the aid of suitable treatment heads of cleaning machines and/or filling machines, and by means of which the removal of the filling product can also be carried out by means of suitable tapping heads. These keg connections are known to the person skilled in the art as fittings or keg fittings. Likewise, the basic structure of such kegs has already long been known to the relevant person skilled in the art.

As a rule, the containers, and in particular also the kegs, are handled in on an industrial scale and in an automated manner in the filling plants, such as the large plants of the beverage industry, for example with cleaning machines and/or filling machines of the type described heretofore. Known for this purpose, for example, are fully-automated machines or systems with one or more stations for the cleaning or filling of the containers, in particular kegs. Such machines and systems can also be referred to as treatment devices or treatment systems.

At the installation of such treatment devices or treatment systems, the corresponding treatment stations are connected on the client's construction site to supply lines and pipelines, in order to provide and ensure the supply of different media, namely treatment and cleaning media, as well as with the filling product which is to be filled. After the connection of the treatment stations to the supply lines and pipelines, a check must be carried out not only as to whether all the pipelines are correctly connected, but also as to whether all the media are available with the desired parameters, such as pressure, volume flow, master guideline value, and/or temperature.

These analyses of the connections and of the problem-free supply are carried out within the framework of function tests or installation tests. In conventional systems, in this situation it is usually the checking and investigating as to whether the connection of all the pipelines are correct which is carried out first, by a trained person, wherein the checks are primarily carried out as visual checks. The maintaining of the process parameters is then likewise determined by a trained person during a test operation run. For this purpose use must be made, for example, of special measuring instruments in specific process steps.

These installation and function examinations or tests, however, are not only time-consuming, labor-intensive, and personnel-intensive, but also require the availability of trained personnel with sufficient experience to carry out the tests and checks and, in particular, to evaluate them correctly. Moreover, specially prepared containers are required for this, which are therefore expensive to provide, kegs in particular, which are fitted with electronic measuring equipment, for example, and for visual monitoring are also configured as glass bodies.

Accordingly, there continues to be a need for the corresponding checks and tests for the completion of installation and the testing of the connections to be simplified, in particular at the production and installation of container handling systems, such as keg handling systems, or when such a system is taken into operation.

### SUMMARY

An object of the present invention is that of providing a simple treatment system for the treatment of containers, in particular kegs, that permits reliable checking and testing the connections and the maintenance of correct process parameters and that thereby saves time and effort on behalf of personnel and also reduces the incidence of faults. in this situation, leads in particular to a saving of time and personnel effort, as well as to the avoidance of faults.

The present invention provides a treatment system for treating containers, in particular for treating kegs, each of which are preferably equipped with at least one keg fitting. The treatment system comprises at least one media supply for a filling product and/or for one or more treatment or cleaning media, as well as at least one treatment station for receiving a container, in particular a keg. The treatment station comprises at least one treatment head for the internal cleaning and/or filling the container, in particular the keg, and at least one supply interface, and is connected to the media supply by means of its supply interface. According to one particular aspect, with the treatment system for an automatic installation test and/or function test of the treatment station, provision is further made for at least one closure device for the tight closing of the treatment head, as well as for at least one measuring and testing device for the acquisition and testing of process data.

In the meaning of the present invention, the treatment system is equipped with a system which allows, in a simple and, at the same time, reliable manner, for all the connections to be checked and tested, as well as the maintaining of the correct process parameters. Human error is thereby reduced.

This present treatment system allows for a simple and automatic analysis and checking or testing, which saves costs and personnel effort, as to whether, at a treatment station, all the connections for the supply with the corresponding media, such as treatment or cleaning media, or with filling product, are configured in the desired, correct, and required manner, such that, with the appropriate switching of valves and therefore the consequent imposition on the treatment head in the correct sequence, the media can be supplied within the specified parameters and parameter ranges, namely, for example, pressure, volume, volume flow, throughflow, master guideline value, and/or temperature. Preferably, the parameters can also be compared with reference values, which are stored, for example, by means of software or a software program. It is also conceivable for a possible adjustment/optimization of the values to be carried out, even of the stored reference values, inasmuch as the values lie within a certain tolerance range.

The automatic analysis and checking or testing described heretofore can, for example, take place as an installation check or check during commissioning before the start of full operation of a newly installed treatment station or a newly installed treatment station. Likewise, however, the automatic checking or testing can also be carried out as a routine checking of the function of the treatment station or of the treatment system, namely as a function check, which can take place, for example, at regular intervals of time, and in particular also for the purposes of maintenance or supervision.

The automatic installation check and/or function check can also provide particular advantages, for example, if a change of filling product is taking place at the treatment station, and a switchover from the filling of one particular filling product to the filling of another product, and, inherently with this product change, there is a switch between different supply lines, the correct connection of which is in this case to be checked at all times.

This present treatment system is therefore a treatment system which is configured such as to carry out an automated self-test or independent test. In the meaning of the present invention, the treatment system is therefore also to be understood as a self-testing or self-checking treatment system, or as a treatment system with self-monitoring or independent-monitoring capability.

The closure device and the measuring and testing device together form essentially a testing or checking system, which in turn preferably represents a part of the overall treatment system and can therefore also be understood as a subordinated treatment system component. In this situation, the closure device and the measuring and testing device communicate with the treatment system or with further components of the treatment system. Provided for this purpose, in particular, are a control unit or a control system.

For the measuring and testing device of the treatment system, measuring instruments and fittings are provided, which can be arranged at suitable locations in order, for example, in mutual interaction, to supply corresponding data and measured values, which in turn, after suitable evaluation and analysis, provide a meaningful result with regard to the problem-free installation and function of the treatment station that is to be examined, in particular of the treatment system.

By contrast with conventional systems and installations with which a function test takes place with the operation of the system in what is referred to as a test operational mode, this present treatment system allows for the installation test and/or function test to be carried out before the actual operation, i.e. prior to the operational mode, and therefore allows for a simple and rapid function testing which is also economical with regard to media and resources.

A “filling product” in the meaning of the present invention can be, for example, a beverage, in particular a beverage containing carbon dioxide. For example, the filling product can be a mixed beer beverage or a carbonated soft drink.

As a “cleaning medium,” there come into consideration all media which are conventionally used in the sector of the foodstuffs industry, in particular the beverage industry, in connection with a cleaning process, which are habitually known to the person skilled in the art. The cleaning can comprise several different cleaning steps with different cleaning media, wherein the several cleaning steps are carried out, for example, sequentially or one after another. Preferably, for the cleaning of the kegs, at least one alkali is used as a cleaning medium or as a constituent of a cleaning medium.

According to one preferred embodiment variant of the invention, the measuring and testing device comprises one or more sensor units. In particular, at least one of the sensor units is configured as a pressure sensor and/or as a volume flow sensor. This at least one pressure sensor and/or volume flow sensor is in this situation configured such as to detect a media pressure and/or volume flow which prevails when the treatment head is subjected to the filling product and/or to the respective treatment medium or cleaning medium.

Particular advantages are derived from the several sensors in that different parameters, in particular multiple parameters, can be measured and checked, in order to test whether the media can be provided at the treatment head, in all the process steps and in all the flow paths provided for this purpose, in the manner desired and required. Advantageously, as a result of this, the different, in particular multiple, parameters can also be detected at different positions and locations of the treatment system. As a result, it also advantageously derives that, with the treatment system, an information fusion or sensor fusion is possible, with which, with suitable methods and means, the data and parameters acquired from different sensor units, in particular sensors or information sources, can be linked together in order to obtain a precise image of all the measured values and results. In this present situation, this can also be understood as data fusion or multi-sensor fusion, and therefore also relates to what is referred to as “divided measurement”.

For further preference, the measuring and testing device further comprises at least one or more fittings units for adjusting the pressure and/or volume flow of the filling product and/or of the treatment media or cleaning media. The fittings units can be provided in or at the closure device, and/or, as an alternative or in addition, also in the region of the supply interface or in the delivery lines to the supply interface. The fittings units can also comprise, for example, several individual fittings, which are arranged at suitable locations on the closure device and/or supply interface and/or the delivery lines to the supply interface, and preferably interact in a communicating manner.

As a result of appropriate communication or appropriate interplay or interaction of the sensor units and the fittings units, it is possible in particular for process parameters to be detected at different fittings settings by means of the sensor units, in order thereby for the connections and function to be checked more precisely and in greater detail. In particular, by means of this present treatment system, the configuration of the infrastructure present at the installation location can be tested. Examples of this are the steam supply, the water supply, and the supply of cleaning medium (CIP), of which the pressure and volume flow in production operation must be constant, at least within certain limits.

For further preference, the measuring and testing device further comprises an evaluation unit for evaluating the process data detected. Particular advantages are derived in this situation due especially to the fact that necessary calculation steps and/or comparison steps are also carried out by means of predetermined and specified comparison and calculation operations. The evaluation, or individual steps of the evaluation, are carried out in this situation preferably automatically by means of an evaluation routine stored in the evaluation unit.

For example, the measuring and testing device can also comprise a storage unit which communicates with the evaluation unit, such that, in particular, the evaluation of the derived data, as well the evaluation protocols and/or evaluation results can be deposited in the memory unit, preferably also for the later use of the data or for documentation purposes.

The closure device is preferably formed by a closure cap which can be connected to the treatment head. Such a closure head can be, for example, a closure cap which can be placed in a sealing position onto the treatment head, which then closes the treatment head, in a state in which it is connected to this head, in a sealing manner, and seals it against the outside environment. Such a closure cap is configured in particular such as to communicate with the treatment station or with the treatment system, and in the present situation can also be designated as a data cap, which is used for a process for the detection and “collecting” of data, such as process data.

For example, the closure cap can be configured as a manually placed closure cap, which can, for example, be screwed onto the treatment head. It is also conceivable, however, that the closure cap is configured as a closure cap which can be delivered by automated means, which interacts with the cap handling device provided at the treatment system for the automated delivery and handling of the closure cap, and can be delivered, by automated means or automatically, to the handling head and placed onto it by the cap handling device.

For particular preference, and in particular in cases in which it is configured as a closure cap, the closure device can also simultaneously form a CIP flushing cap, and at the same time can be used for a CIP cleaning process, as a result of which, in particular, the CIP cleaning process can be monitored in real time. Typical parameters for monitoring in this situation are, for example, the temperature and the master guideline value.

According to an alternative embodiment variant, however, the closure device can also be formed by a dummy keg, which can be connected to the treatment head. Such a dummy keg is provided with at least one connecting and closing section, or, for example, with a keg fitting, in order to create and establish the sealed connection to the treatment head or the sealed link to the treatment head. Such a dummy keg is itself, for example, equipped with parts of the measuring and testing device, preferably with sensor devices or sensors, and is preferably provided with communication means for communication with the treatment station or with the treatment system respectively. The dummy keg is therefore configured in particular such as to communicate with the treatment system, and in this situation can also be designated as a data keg, which is used for the detecting and “collecting” of data, such as process data.

The measuring and testing device is preferably arranged at least partially at the closure device and/or at the supply interface. It is also possible for parts of the measuring and testing device to be arranged in the region of the delivery lines to the supply interface. In particular, with regard to the measuring and testing device, individual measuring units or measuring instruments or individual sensor units or sensors are provided, these being arranged in the region of the closure device and/or in the region of the supply interface, for example fitted there or integrated. It is also possible for individual measuring units or measuring instruments or sensor units or sensors to be located in the delivery lines to the treatment head or to the supply interface,

According to one particularly preferred embodiment variant, the supply interface comprises at least one valve arrangement, with several switching valves, in particular a valve node, for the controlled delivery of media.

Preferably, an instrumentation and control device is provided at the handling system, wherein at least the closure device and the measuring and testing device, as well as the supply interface are connected in a communicating manner to the instrumentation and control device.

Preferably, the instrumentation and control device is programmed in such a way as to switch the switching valves of the valve arrangement in a controlled manner, in order to set defined switching states and, as a dependency of the switching states which have been set, to evaluate and analyze the process data detected by the measuring and testing device.

According to a further preferred embodiment variation of the invention, the treatment station further comprises at least one pressing element for pressing the keg against the treatment head, wherein the closing device and the pressing element interact in a corresponding manner in order to press the closing device in a tightly sealed manner against the treatment head during the automatic installation test and/or function test.

The treatment system preferably further comprises several treatment stations, in particular of the same type, wherein each treatment station comprises in each case a closing device for the sealing tight closing of its treatment head, and wherein, for the detection and checking of process data, at least one common measuring and testing device is provided for all the treatment stations, or, in each case, an individual measuring and testing device is provided for each treatment station.

The present invention further relates to a closure device for use with an automatic installation test and/or function test of a treatment station of a treatment system, wherein the closing device is configured for the tight closing of a treatment head of the treatment station. Preferably, the closing device is equipped with one or more sensor units and/or with one or more fitting units of a measuring and testing device.

The present invention further relates to a method for the installation testing and/or function testing of a treatment station of a treatment system, as has been described heretofore. With the method, first a closing device for the tight sealing of the treatment head of the treatment station is placed in a sealing position onto the treatment head. The treatment head is then subjected to a filling product and/or to at least one treatment medium or cleaning medium from the medium supply, and, by means of at least one measuring and testing device, process data is acquired and checked.

The present invention serves not only to carry out the function test of the treatment station, but also the function test of the fittings connected to the treatment station, wherein, for example, the existing infrastructure can also be tested. Examples of this are steam supply, water supply, and the supply of cleaning media (CIP). In other words, by means of the method the media supply can also be tested.

Preferably, the method can be carried out as a testing at the taking into operation or commissioning of the treatment station of the treatment system, in order to test the connections of the supply interface to the media supply and/or to test the function of the supply interface.

For further preference, for the imposing of the filling product onto the treatment head, and/or with at least one treatment medium or cleaning medium, switching valves of a valve arrangement of the supply interface can be switched in a controlled manner, and thereby defined switching states are adjusted and set. In this situation, as a dependency of the switching states which have been set, the process data detected by the measuring and testing device is evaluated and analyzed, and, in particular, the time sequence of processed data items detected in a time sequence from one another is analyzed.

The invention further relates to a software program for a treatment system such as has been described heretofore, wherein the software program comprises commands which have the effect that the treatment system carries out the method described heretofore, when the software program is run by an instrumentation and control device of the treatment system.

### BRIEF DESCRIPTION OF THE FIGURES

The invention is explained in greater detail hereinafter on the basis of the figures relating to exemplary embodiments, in which:

FIG. 1 shows a keg having been received for treatment at a treatment station;

FIG. 2 shows the treatment station of FIG. 1 with a closure device having been connected to the treatment head;

FIG. 3 shows one arrangement of a testing device;

FIG. 4 shows details of a treatment head with a keg mounted thereon, and

FIG. 5 is a plan view of a treatment system having treatment stations as shown in FIG. 1.

Identical reference numbers are used in the figures for elements which are the same or have the same effect. Moreover, for the sake of easier overview, only reference numbers are represented in the individual figures which are required for the description of the respective figure concerned. The invention is also represented in the Figures only in a schematic view in order to explain the mode of operation. In particular, the representations in the figures serve only to explain the basic principle of the invention. For reasons of easier overview, not all the component parts of the device have been shown.

### DETAILED DESCRIPTION

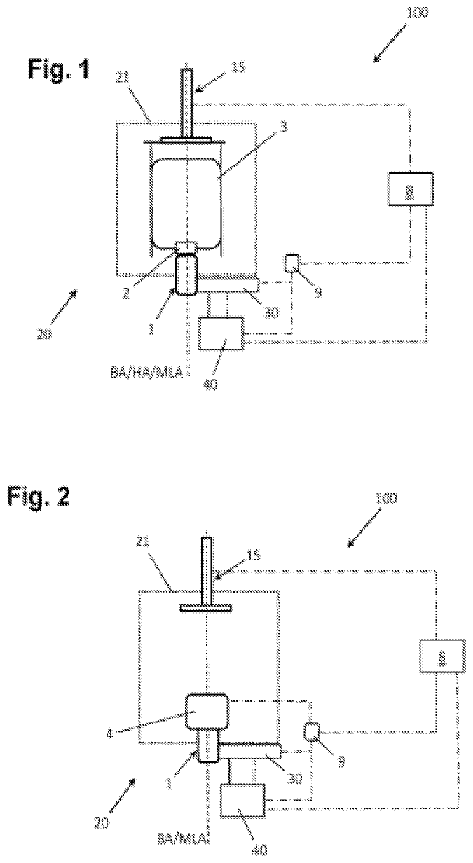

FIG. 1 shows a treatment system 100 that cleans and fills kegs 3.

The keg 3 is an essentially cylindrical barrel that extends along a keg axis HA. The keg 3 has an underside and an upper side that face each other. The underside forms the barrel's base. A casing forms a side wall that connects the upper side and the underside. A keg fitting 2 on the keg's upper side is used for cleaning the keg's interior 3.1 and for filling the keg with a liquid filling-product, such as a beverage. The keg fitting 2 is typically positioned so that the keg axis HA passes through it.

The keg fitting 2 forms first and second openings. The first opening is coaxial with the keg axis HA. It connects to an end of a riser pipe that extends through the keg's interior 3.1 along the keg axis HA. The second opening is an annular opening around the riser pipe to form a ring channel. The keg fitting 2 includes a self-closing valve that is biased by a spring to close the openings. This valve can be opened for cleaning and/or filling the keg 3.

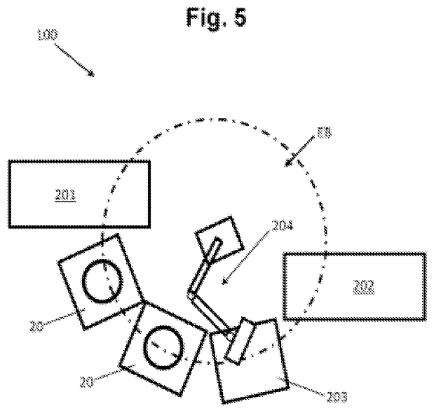

The treatment system 100 includes one or more treatment stations 20. Examples of a treatment station 20 include a cleaning station, a filling station, and a combined cleaning and filling station, the latter being shown in FIG. 1 and also in FIG. 2. As shown in FIG. 5, the treatment system 100 typically includes plural treatment stations 20. Each treatment station 20 is an independent treatment module that receives a single keg 3 for treatment thereof. Each treatment station 20 transitions between an operating state, as shown in FIG. 1, and a testing state, as shown in FIG. 2.

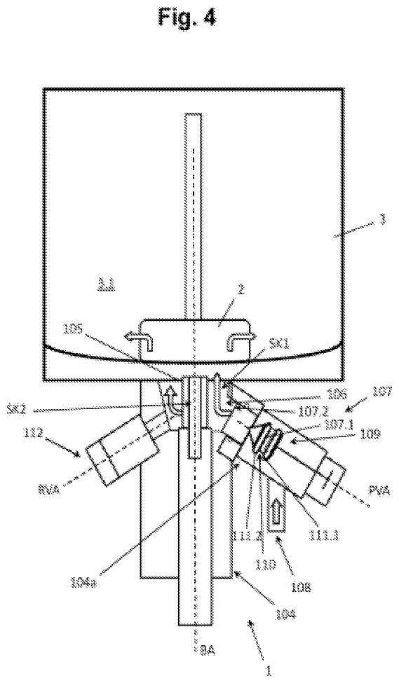

The treatment station 20 includes a treatment head 1, a pressing element that presses the treatment head 1 against the keg fitting 2 to form a seal, and an optional housing 21 that receives the keg 3. In the illustrated embodiment, the treatment head 1 is a combined cleaning and filling head for the internal cleaning and filling the keg 3 during its operating state, as shown in FIG. 1. Such a treatment head 1 is described in more detail in connection with FIG. 4.

The pressing element 15 is mounted such as to be displaced along a mid-length axis MLA and to exert a force that presses downwards onto the keg 3. The pressing element 15 and the treatment head 1 cooperate to engage and grip the keg 3 on its upper side and underside, and to thereby hold the keg 3 in a stable position.

A supply interface 30 at the treatment station 20 connects to a media supply 40 for providing filling product and/or for one or more treatment or cleaning media that is to be conveyed ultimately to the keg's interior 3.1. The supply interface 30, media supply 40, and treatment head 1 include valves that can be controlled or regulated to switch between open and closed positions for delivery of media into the keg 3 and/or discharge of media from the keg 3 in an orderly sequence.

An instrumentation-and-control device 8 (hereafter referred to as the “controller 8”) provides the foregoing control and regulation. The controller 8 optionally communicates with an additional central control unit of the treatment system 100. In some embodiments, the controller 8 is itself part of a central control unit of the treatment system 100 or forms the central control unit of the treatment system 100.

In addition to controlling the delivery into the keg 3 and the discharge of media from the keg 3, the controller 8 also controls the pressing element 15, and in particular, the movement of the pressing element 15 along the mid-length axis MLA to press the keg 3 against the treatment head 1.

In FIG. 1, the treatment station 20 is in its operational state and thus fully functional. Before being in this state, it is it is necessary to establish all connections between the treatment station 20 and the media supply 40 and to do so correctly and securely so that they function perfectly. This has to be carried out when a treatment station 20 is first installed as well as for routine checks or maintenance, for example testing, and also for conversion of re-equipping the treatment station 20.

FIG. 2 shows the treatment station 20 in a testing state, prior to the operational state of FIG. 1. In this state, the keg 3 is missing. Instead, a closure 4 is sealed against the treatment head 1. The closure 4 and a measuring-and-testing device 9 (hereafter referred to as “testing device” for brevity) cooperate to assist in monitoring the installation process and in testing its function. For the monitoring of the installation and function. As shown in the figure, the closure 4 is sealed to the treatment head 1.

In the example represented in FIG. 2, the closure 4 comprises a cap that is connected to the treatment head 1, for example by being screwed onto the treatment head 1. The closure 4 comprises a receiving section for receiving the treatment head 1. As a result, at least part of the treatment head 1 fits into the receiving section to form either a positive fit or a non-positive fit.

In an alternative embodiment, the pressing element 15 is configured to travel sufficiently far along the axis MLA to press the closure 4 into a sealing position against the treatment head 1.

The testing device 9 receives and evaluates process data to check whether all the media lines, pipelines, delivery lines and the like have been correctly connected to the treatment station 20 and whether, as a consequence of the correct and secure connections, all the media are available at the treatment head 1 of the treatment station 20 with the desired parameters such as pressure and volume flow.

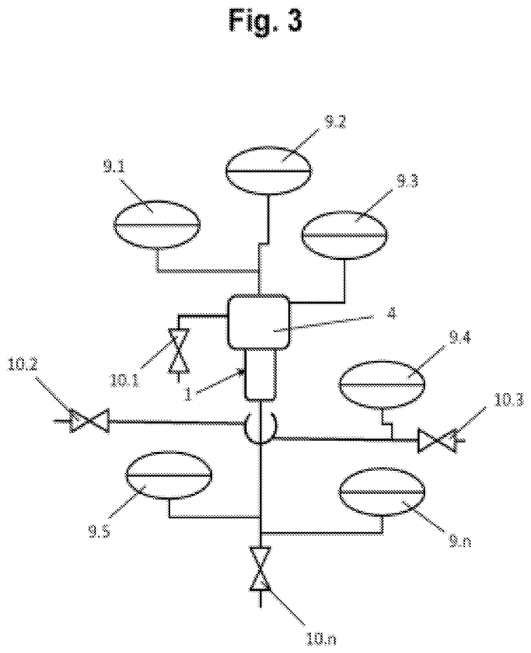

Referring now to FIG. 3, the testing device 9 includes sensors 9.1-9.n, among which are a pressure sensor and a volume-flow sensor, the latter measuring a volume rate-of-flow. These provide pressure and flow measurements of media during testing. As a result of its connection with the closure 4 and a connection with the controller 8, it is possible to take into account and act on data provided by the sensors 9.1-9.n.

In the examples represented, the individual sensors 9.1-9.n are disposed in the region of the closure 4 itself and/or along the supply line 40. As shown in FIG. 3, first, second, and third sensors 9.1, 9.2, 9.3 are arranged at or in the closure device 4 and the remaining sensors 9.4, 9.5, 9.n are arranged at a suitable location inside the treatment system 100, namely in the supply interface 30 and the media supply line 40.

The testing device 9 further comprises fittings 10.1-10.n, 10.2, 10.2 for adjusting the pressure and/or volume flow of the filling product and/or of the treatment or cleaning media. The fittings 10.1-10.n are also arranged at suitable locations of the treatment system 100. In the example shown in FIG. 3, a first fitting 10.1 is provided at the closure 4 and the remaining fittings 10.2, 10.3, 10.n are provided at other suitable locations inside the treatment system 100, such as the supply interface 30 and the media supply line 40.

The testing device 9 further comprises an evaluation unit that evaluates the acquired process data, for example by comparing it with predetermined values and parameters. A suitable evaluation unit is a data-processing unit or a processing and calculating unit.

In such cases, the evaluation unit stores evaluation programs or evaluation routines, including comparison routines, in the evaluation unit or in a memory unit. The acquired process data, as well as the processed data and results are then stored in this memory to be retrieved for later use or for documentation.

In some embodiments, the testing device 9 includes an optional output unit to output the measuring and testing results. Examples of an output unit include a display, such as a warning light, or a sound. Other examples include a monitor.

FIG. 4 shows details of a multifunctional treatment head 1 for the internal cleaning and filling of kegs 3.

The treatment head 1 includes a housing 104 and a plunger 105. The plunger 105 is at least partially accommodated within a cavity defined by the treatment head housing 104 and is held in the treatment head housing 104 such as to be displaceable along a treatment-head axis BA to open and close the keg fitting 2.

The cavity further forms a fluid chamber 106 and first and second flow paths SK1, SK2 that provide fluid communication with the fluid chamber 106. These are connected in a controlled manner with the keg's interior once the keg's fitting 2 is sealed onto the treatment head 1. The first flow path SK1 provides media or filling product and the second flow path SK2 drains media used for cleaning the keg 3. In some embodiments, the second flow path SK2 extends at least partially through the plunger 105.

The treatment head 1 further includes two controllable valves, both of which connect to the fluid chamber 106: a product valve 107 and a return valve 112. The product valve 107 extends along a product-valve axis PVA and the return valve 112 extends along a return-valve axis RVA. Both the product valve and the return valve 107, 112 connect to a valve-housing section 104a at a transition section or valve-transition section of the treatment-head housing 104. In some embodiments, the valve-housing section 104a is an integral part of the treatment head housing 104.

The valve-housing section at least partially accommodates a valve body 107.1 of the product valve 107. An actuator moves the valve body 107.1 along the product-valve axis PVA. In its closed position, the valve body 107.1 forms a seal with a valve seat 107.2 that is formed within the valve-housing section 104a. In its open position, the product valve 107 provides a fluid connection between a filling-product delivery line 108 and the fluid chamber 106 via the first flow path SK1. The controller 8 controls and monitors the product valve 107 and the media valve 112.

The product valve 107 comprises a double-seat valve having first and second sealing elements 11.1, 111.2 that form a flushable security-and-leakage chamber 110, hereafter referred to as the “security chamber 110” for brevity. This product valve 107 is thus a multiple-seal arrangement 109 that provides two or more separate and distinct seals between the filling-product delivery line 108 and the fluid chamber 6. This multiple-seal arrangement promotes a reliable separation between the filling product and the cleaning media or cleaning means. In the product valve's closed position, this security chamber 110 forms a separated intermediate space between the fluid chamber 106 and the filling-product delivery line 108, and therefore reliably separates and seals the filling-product delivery line 108 and the fluid chamber 106 from each other.

A typical cleaning and filling process begins with bringing an empty keg 3 into the treatment station 20 and using the pressing element 15 to seal its keg fitting 2 against with the treatment head 1. The plunger 105 opens the keg fitting 2 to set in motion a multi-step cleaning process for cleaning the keg's interior 3.1. Each step includes delivery of a cleaning medium through the treatment head 1 and removal of the treatment medium via the return valve 112. During the entire interior cleaning, the product valve 107, which is connected to the filling-product delivery line 108, remains closed, thus forming the security chamber 110.

Upon completion of the interior cleaning, the product valve 107 is brought into a middle valve-setting to allow a flushing device to flush the security chamber 110, including a head space and/or dead space therein. Examples of a flushing device include a flushing valve, a satellite valve, and/or a controlled outlet to the outside. The flushing and emptying of the security chamber 110 is carried out in a controlled manner to keep the security chamber 110 space open or closed as required.

After this flushing step, the product valve 107 is brought in a controlled manner into its filling position for the actual filling of the keg 3 with filling product. Delivery of the filling product is continues until the product valve 107 returns to its closed position.

FIG. 5 shows a treatment system 100, also referred to as a “treatment installation,” that includes several treatment stations 20 of the type described above as well as an additional treatment module 203 that differs from the treatment stations 20. The treatment system 100 includes inlet region 201 that conveys kegs 3 to be cleaned and filled is conveyed to the treatment system 100 and an outlet 202 that conveys away kegs 3 that have been treated and filled. The inlet 201 and/or the outlet region 202 include a transport device, such as a conveyor.

The illustrated embodiment shows two treatment stations 20 and a further treatment module 202 between the inlet 201 and the outlet 202. However, other configurations of treatment stations 20 and treatment modules 203 are possible.

The treatment system 100 also includes a loading robot 204 that delivers kegs 3 to treatment stations 20 and treatment modules 203 and also removes kegs 3 from treatment stations 20 and treatment modules 203. Examples of a loading robot 204 include a jointed arm robot, such as a five-axis or six-axis folding-arm robot.

The treatment stations 20 and treatment modules 203 all lie within a detection region EB of the loading robot 204. Within the detection region EB, the treatment stations 20 and treatment modules 203 can be arranged in a flexible manner and can thus differ considerably from that shown in FIG. 5.

The treatment stations 20 and treatment modules 203 are operable independently of one another. As a result, the treatment steps can differ from among the treatment stations 20 and treatment modules 203. Such differences include differences in the lengths of treatment steps and the number of treatment steps. As a result, it is possible to tailor a treatment procedure for a particular keg 3 without affecting the treatment procedures of other kegs 3.

The treatment system 100 thus avoids the conventional method of using conveyors to move kegs 3 past various function devices, e.g., printers, cappers, cap drawers, etc. Instead, the treatment system 100 relies on a robot 204. To permit this to occur, the various function devices are arranged to lie along the robot's travel path. This eliminates the need for separate conveyors. Moreover, the configuration shown also means that one can carry out the different functions of the function devices on the keg 3 without the need for diversions, and therefore with optimum use of time.

Having described the invention and a preferred embodiment thereof, what is new and secured by Letters Patent is:

1-19. (canceled)

20. An apparatus for treating a keg that comprises a keg fitting, said apparatus comprising a media supply, a treatment station, a supply interface, a closure, and a testing device, wherein said media supply provides filling product and treatment media, wherein said supply interface connects said treatment station to said media supply, wherein said treatment station transitions between an operating state and a testing state, wherein, in said operating state, said treatment station receives said keg and carries out internal cleaning and/or filling of said keg, and wherein, in said testing state, said closure seals said treatment head and said testing device acquires process data for automatic installation and/or function testing of said treatment station.

21. The apparatus of claim 20, wherein said testing device comprises a pressure sensor and a volume-flow sensor, wherein said pressure sensor measures media pressure during said automatic installation and/or function testing of said treatment station, and wherein said volume-flow sensor senses volume flow during said automatic installation and/or function testing of said treatment station.

22. The apparatus of claim 20, wherein said testing device further comprises fittings for adjusting pressure and volume flow during said automatic installation and/or function testing of said treatment station.

23. The apparatus of claim 20, wherein said testing device further comprises an evaluation unit for evaluating said acquired process data.

24. The apparatus of claim 20, wherein said closure comprises a cap that connects to said treatment head.

25. The apparatus of claim 20, wherein said closure comprises a dummy keg that connects to said treatment head.

26. The apparatus of claim 20, wherein said testing device is arranged in part at said closure and at said supply interface.

27. The apparatus of claim 20, wherein said supply interface comprises a valve arrangement with several switchable valves for controlled delivery of media.

28. The apparatus of claim 20, further comprising a controller that is in communication with said closure, said testing device, and said supply interface.

29. The apparatus of claim 20, further comprising a controller that is programmed that causes a valve node of said supply interface to transition between switching states by controlled switching of valves in said valve node and to evaluate and analyze process data acquired by said testing device as a result of having caused said transition.

30. The apparatus of claim 20, wherein the closure comprises a CIP-flushing cap.

31. The apparatus of claim 20, further comprising a pressing element that carries out a first stroke and a second stroke that is longer than said first stroke, wherein said pressing element executes said first stroke to press said keg against said treatment head during said operating phase and wherein said pressing element executes aid second stroke to press said closure against said treatment head during said testing phase.

32. The apparatus of claim 20, wherein said treatment station is one of a plurality of treatment stations of the same type and wherein said testing device is common to all of said treatment stations.

33. An apparatus for use with a treatment station that treats a keg that comprises a keg fitting, wherein said treatment station transitions between an operating state, in which said treatment station receives said keg and carries out internal cleaning and/or filling of said keg using media and/or filling product received from a media supply, and a testing state, during which a testing device acquires process data for automatic installation and/or function testing of said treatment station, said apparatus comprising a closure that seals a treatment head of said treatment station during said automatic installation and/or function testing of said treatment station.

34. The apparatus of claim 33, further comprising sensors and fittings, wherein said sensors are disposed at said closure and provide said process data to said testing device and wherein said fittings control process parameters.

35. A method comprising carrying out automatic testing of a treatment station that transitions between an operating state, in which said treatment station receives a keg that comprises a keg fitting and carries out internal cleaning and/or filling of said keg using a supply interface connects said treatment station to a media supply that provides filling product and treatment media, and a testing state, wherein carrying out said automatic testing comprises causing a closure to seal a treatment head of said treatment station, subjecting said treatment head to a filling product and/or to at least one treatment or cleaning medium from said media supply, and using a testing device to acquire process data.

36. The method of claim 35, further comprising installing said treatment station into a treatment system prior to carrying out said automatic testing thereof in order to test connections of said supply interface to said media supply and to confirm correct functioning of said supply interface prior to using said treatment station in said operating state in said treatment system.

37. The method of claim 35, wherein carrying out said automatic testing of said treatment station comprises causing an arrangement of valves in said supply interface to transition in a controlled manner between switching states, acquiring and collecting process data during each of said switching states, thereby acquiring a temporal sequence of process data for evaluation and analysis, and evaluating and analyzing said temporal sequence of process data.

38. A manufacture comprising a tangible and non-transitory computer-readable medium having instructions that, when executed by a controller, cause said controller to carry out automatic installation and/or function testing of a treatment station during a testing state thereof, wherein said treatment station transitions between said testing state and an operating state, in which said treatment station receives a keg that comprises a keg fitting and carries out internal cleaning and/or filling of said keg using a supply interface connects said treatment station to a media supply that provides filling product and treatment media, wherein, in said testing state, a closure seals said treatment head and a testing device acquires process data and provides said process data to said controller for evaluation thereof.
